(19) United States
(12) Patent Application Publication
(10) Pub. No.: US 2026/0328423 A1
(43) Pub. Date: Oct. 22, 2026

(54) Symbiotic Repeater System with Remote Manageability

(71) Applicant: Airgain, Inc., San Diego, CA (US)

(72) Inventors: Cheng Yuan Chin, San Diego, CA (US); Shenjie Miao, San Marcos, CA (US); Ali Sadri, San Diego, CA (US)

(73) Assignee: Airgain, Inc., San Diego, CA (US)

(21) Appl. No.: 19/529,272

(22) Filed: Feb. 4, 2026

Related U.S. Application Data
(60) Provisional application No. 63/761,242, filed on Feb. 21, 2025.

(51) Int. Cl. F24F 11/58; H04B 7/155; H04L 12/28

(52) U.S. Cl. CPC F24F 11/58; H04B 7/155; H04L 12/2825; H04L 2012/2841

(57) ABSTRACT

A symbiotic repeater system with remote management capabilities and fully powered by renewable energy is disclosed herein. The PGS provides power to the repeater while repeater provides internet access to the PGS. The PGS includes at least one power generating unit, a charge controller, a battery unit, and a PGS remote management module comprising a remote management (RM) antenna. The repeater sub-system includes a service unit (SU) antenna, a SU transceiver, a SU remote management module, a digital processing unit, a donor unit (DU) antenna, and a DU transceiver.

### CROSS REFERENCE TO RELATED APPLICATION

The Present Application claims priority to U.S. Provisional Patent Application No. 63/761242, filed on Feb. 21, 2025, which is hereby incorporated by reference in its entirety.

### STATEMENT REGARDING FEDERALLY SPONSORED RESEARCH OR DEVELOPMENT

Not Applicable

### BACKGROUND OF THE INVENTION

### Field of the Invention

The present invention generally relates to repeater systems.

### Description of the Related Art

A repeater system is an automated radio communication station that is typically located in a remote location and extends the range of communications. A repeater system simultaneously receives a wireless communication signal and retransmits the signal at a higher power so that it can cover greater distances. Typically the repeater system consists of a controller device combined with a receiver operating at one frequency and a transmitter operating at a different frequency. When the receiver receives a wireless communication signal, the controller activates the transmitter, which then simultaneously retransmits the received wireless communication signal. A typical repeater system has a frequency range of 150 MHz to 900 MHz. A typical repeater system is installed on a mountain or tall building.

The prior art discusses various repeater systems. However, what is needed is repeater system with remote management capabilities, fully powered by renewable energy.

### BRIEF SUMMARY OF THE INVENTION

The present invention is a symbiotic repeater system with remote management capabilities, preferably fully powered by renewable energy. The symbiotic repeater system ensures sustainable operation while enabling seamless remote management.

The operation band of a remote management module (RMM) is preferably the sub-band of the repeater system.

The present invention includes a service unit (SU) antenna on a repeater system that couples to a RM antenna for one or more RMMs.

The present invention is preferably a standalone symbiotic system where a power generating system (PGS) provides power to the repeater while the repeater provides wireless communication access (such as the internet) to the PGS. Multiple PGSs are not only used to power the repeater system but also support other optional systems, such as HVAC and lighting for the repeater system.

An intra-module is preferably applied to the repeater system and all the PSG.

Artificial intelligence (AI) is preferably used to manage the power consumption for each PSG and intelligently prioritizes power distribution for all electrical loads on the repeater system to maximize overall system uptime.

Also, reusing a SU antenna for the RMM reduces the system complexity and cost.

One aspect of the present invention is a system comprising a power generating sub-system (PGS) and a repeater sub-system. The PGS comprises at least one power generating unit, a charge controller, a battery unit, and a PGS remote management module comprising a remote management (RM) antenna. The repeater sub-system comprises a service unit (SU) antenna, a SU transceiver, a SU remote management module, a digital processing unit, a donor unit (DU) antenna, and a DU transceiver. The PGS is configured to provide power for the repeater system while the repeater system is configured to provide wireless communication access (such as the internet) for the PGS.

Another aspect of the present invention is a system comprising a first PGS, a second PGS, and a repeater sub-system. The first PGS comprises at least one power generating unit, a charge controller, a battery unit, and a first PGS intra-remote management module comprising a RM antenna. The second PGS comprises at least one power generating unit, a charge controller, a battery unit, and a second PGS intra-remote management module comprising a RM antenna. The repeater sub-system comprises a SU antenna, a SU transceiver, an intra-remote management module, an inter-remote management module, a digital processing unit, a DU antenna, and a DU transceiver. The repeater sub system intra-remote management module is connected to the first PGS intra-remote management module PGS and the second PGS intra-remote management module. The first PGS or the second PGS is configured to provide power for the repeater system while the repeater system is configured to provide wireless communication access (such as the internet) for the first PGS and the second PGS.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is an illustration of a repeater system with remote management capabilities.

FIG. 2 is an illustration of an example of the repeater system with remote management capabilities.

FIG. 3 is an illustration of a power generating system with remote management capabilities.

FIG. 4 is an illustration of a PGS connecting with repeater system in a secluded area.

FIG. 5 is an illustration of a SU antenna compatible with the RM antenna for repeater and PGS.

FIG. 6 is an illustration of an example of PSG connecting with repeater system.

FIG. 7 is an illustration of a power supply and internet access flow between the PGS and repeater system.

FIG. 8 is an illustration of multiple PGS coupled to a repeater system with intra-and inter-remote management module pair.

FIG. 9 is an illustration of an example of one repeater system providing internet access to multiple PGS units.

FIG. 10 is an illustration of a cloud AI introduced to manage the multiple PGS.

FIG. 11 is an illustration of an example of AI power supply management.

FIG. 12 is a block diagram of a system of the present invention.

### DETAILED DESCRIPTION OF THE INVENTION

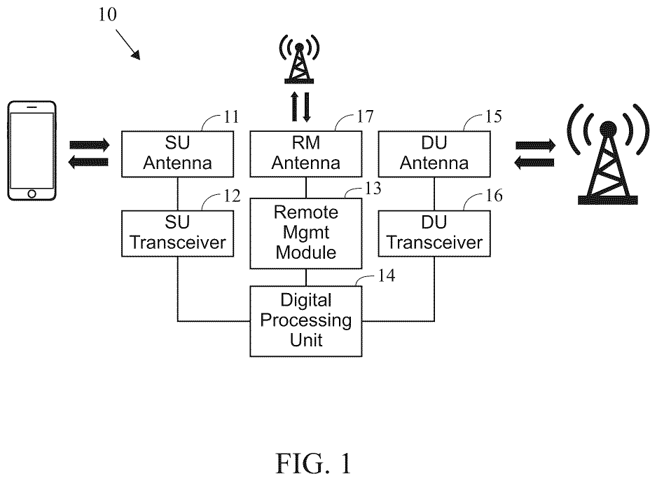

FIG. 1 is an illustration of a repeater sub-system 10 with remote management capabilities. In FIG. 1, the digital processing unit 14, service unit (SU) transceiver 12, and donor unit (DU) transceiver 16 form the RF core responsible for signal enhancement, serving as the “heart” of the repeater system 10. The remote management module (RMM) 13 enables remote access via a wireless communication network (such as the internet). The SU antenna communicates with user equipment (UE) such as mobile communication devices (e.g., phones and table computers), while the DU antenna 15 connects to base stations. The base stations include ground base stations, aerial base stations, satellite base stations, maritime base stations, mobile base stations, etc.

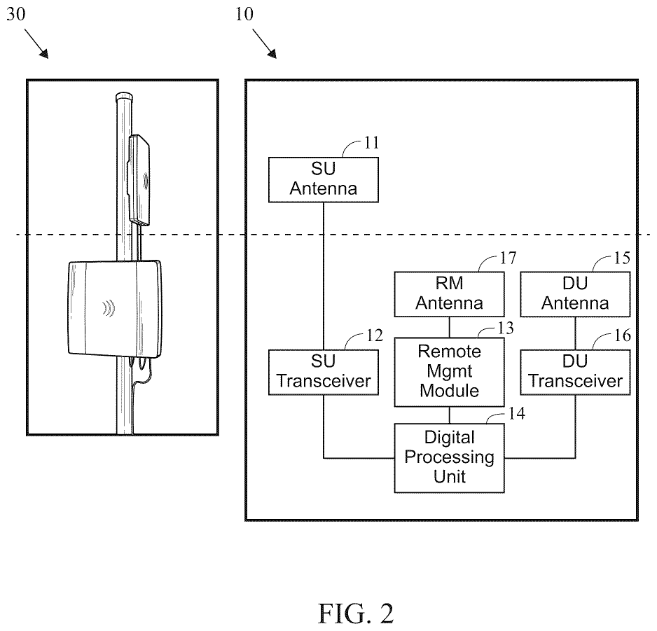

FIG. 2 is an illustration of an example of the repeater sub-system 10 with remote management capabilities. The repeater system 10 can be implemented in different forms. An example of a 2-box design 30 is shown on the left.

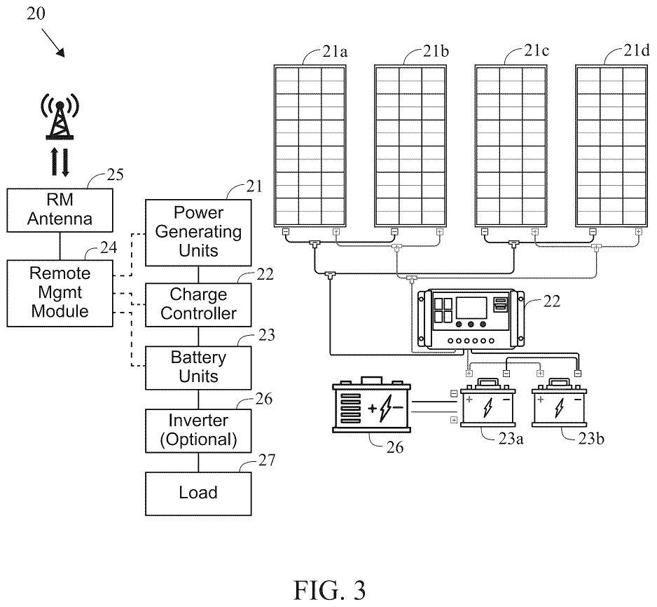

FIG. 3 illustrates a power generating system 20 with remote management capabilities. The power generating units 21/21a-21d, the charge controller 22, the battery units 23/23a-23b, and the inverter 26 are essential components for converting energy into electrical power. The remote management module 24 and RM antenna 25 enable remote access via a wireless communication network (such as the internet). The power sources include renewable energy, such as solar, wind, hydro, and geothermal. Preferably, solar panels are the power generating units 21. Alternatively, wind power from a windmill power generating unit can generate electrical power for the repeater system 10. Still further, hydro power from a dam as the power generating unit can generate electrical power for the repeater system 10. Yet further, geothermal power from a geothermal plant as the power generating unit can generate electrical power for the repeater system 10. Those skilled in the pertinent art will recognize that other renewable source of energy can be utilized without departing from the scope and spirit of the present invention.

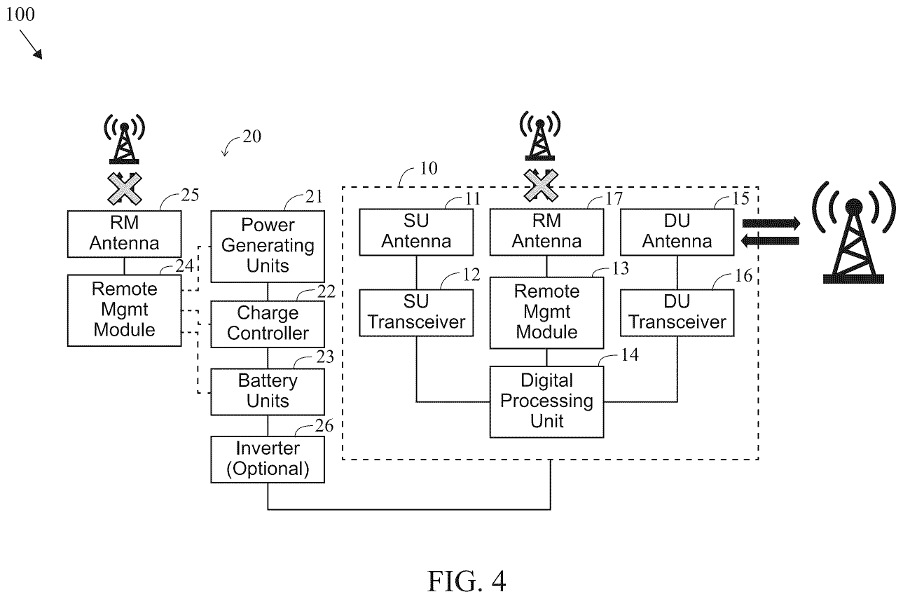

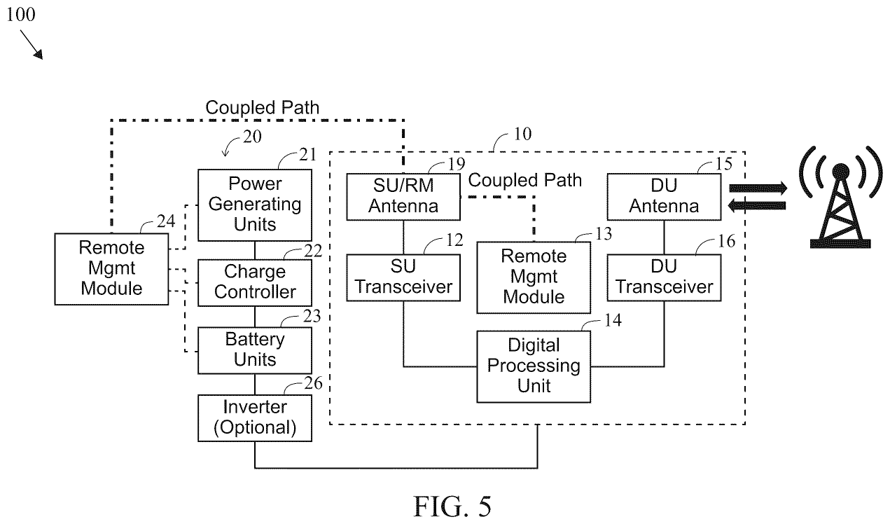

FIGS. 4 and 5 show how the PGS 20 connects with a repeater system 10 in a secluded area when the RMMs 24, 13 each lose connection to the base stations due to the remoteness in a secluded area. A SU antenna is compatible with the RM antenna 19 for the repeater sub-system 10 and PGS 20. The RM antennas 17, 25 are removed in FIG. 5 (to show a connection loss), but remote access capabilities for the PGS 20 and the repeater system 10 are maintained through the SU/RM antenna 19. Both remote management modules 24, 13 for the PGS 20 and repeater system 10 are coupled to the SU/RM antenna 19, allowing it to not only provide signal coverage for UEs but to also serve as the internet connection for the remote management modules 24, 13. Each of coupled paths between the SU antenna 19 and the RMM 24 and RMM 13 can be wired or wireless.

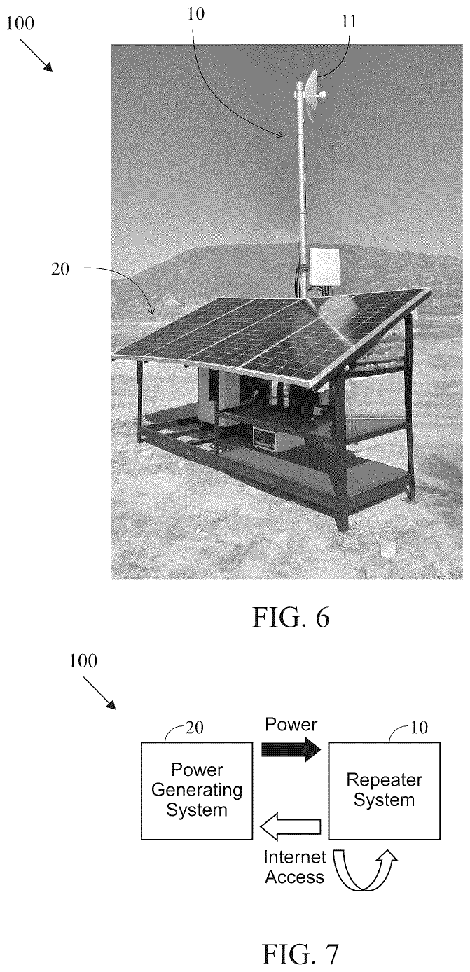

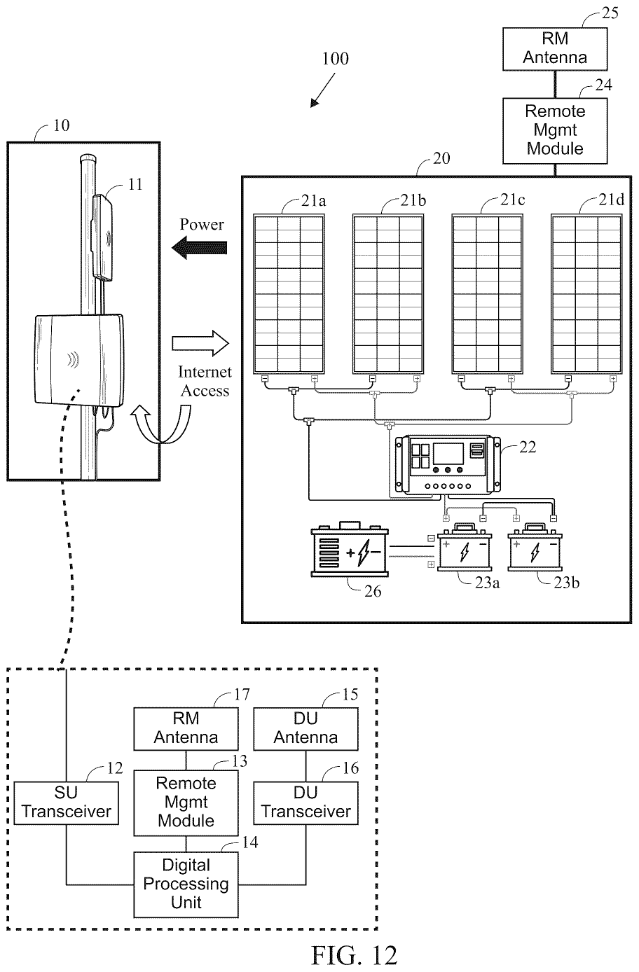

FIG. 12 (as well as FIGS. 6, 7) is an illustration of a preferred embodiment of a system 100 of the present invention. The system 100 comprises a PGS 20 comprising at least one power generating unit 21a-d, a charge controller 22, a battery unit 23, and a PGS RMM 24 comprising a RM antenna 25; a repeater sub-system 10 comprising a SU antenna 11, a SU transceiver 12, a SU remote management module 13, a digital processing unit 14, a DU antenna 15, and a DU transceiver 16, and a RM antenna 17. The PGS 20 is configured to provide power for the repeater system 10 while the repeater system 10 is configured to provide wireless communication access for the PGS 20.

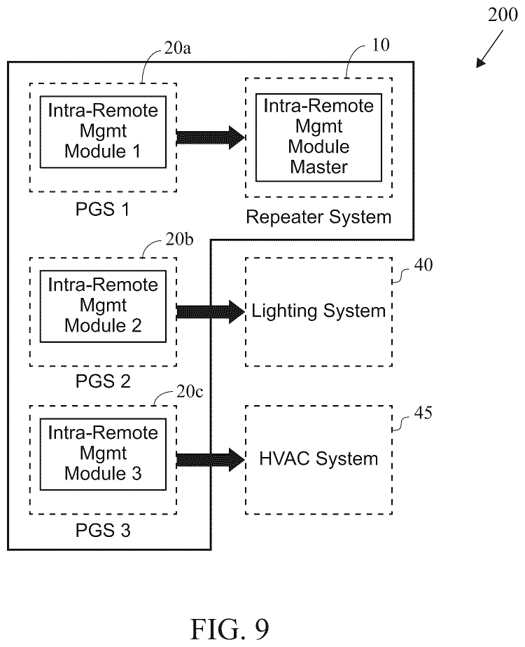

In reference to FIGS. 3 and 9, the PGS 20 further comprises an inverter 26 and a load 27. The load is an HVAC unit 45 or a lighting sub-system 40.

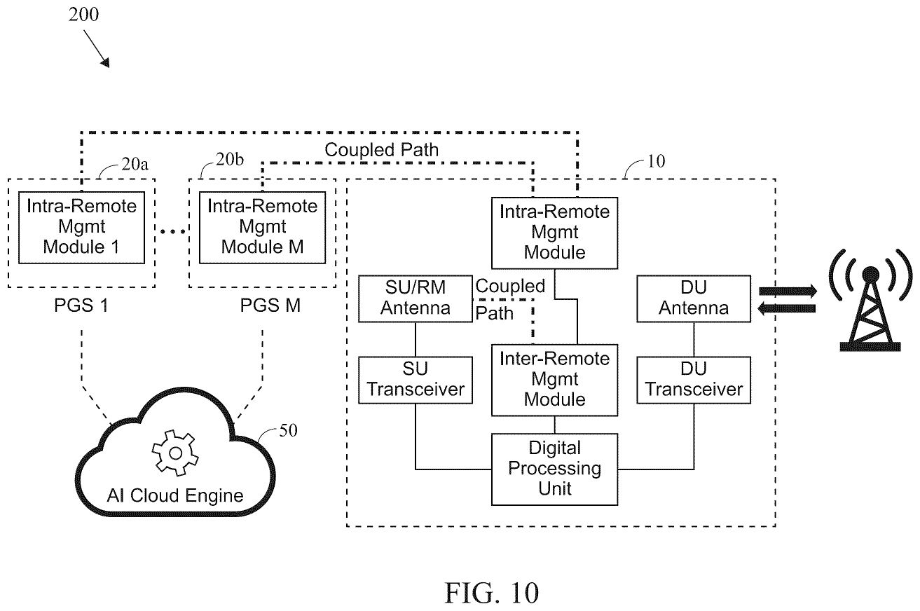

In the system 100, an artificial intelligence engine 50 (see FIG. 10) at a remote server is configured to prioritize power distribution for all electrical loads on the repeater system 10 to maximize overall system uptime.

FIG. 6 is a photographic image of an example of a PSG 20 connecting with a repeater system 10. The dish antenna installed on the top serves as the SU antenna 11.

FIG. 7 is a block diagram of the power supply and internet access flow between the PGS 20 and the repeater system 10. The power flow arrow indicates that the PGS 20 supplies power to the repeater system 10. The two internet access arrows show that the repeater system 10 can connect to the internet while also providing internet access to the PGS 20. This block diagram corresponds to the example shown in FIG. 5.

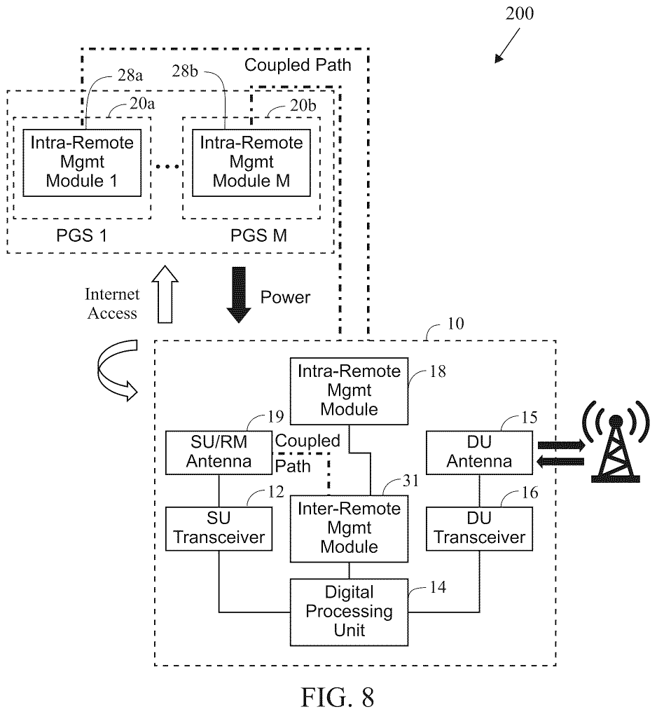

FIG. 8 is an illustration of another embodiment of a system 200 of the present invention. The system 200 comprises a first PGS 20a, a second PGS 20b, and a repeater sub-system. Each of the first PGS 20a and second PGS 20b comprises at least one power generating unit 21, a charge controller 22, and a battery unit 23 (shown in FIG. 3). Each also comprises an intra-remote management modules 28a, 28b with RM antennas. The repeater sub-system 10 comprises a SU antenna 19, a SU transceiver 12, an intra-remote management module 18, an inter-remote management module 31, a digital processing unit 14, a DU antenna 15, and a DU transceiver 16. The repeater sub system intra-remote management module 18 is connected to the first PGS 20a intra-remote management module 28a and the second PGS 20b intra-remote management module 28b. The first PGS 20a or the second PGS 20b is configured to provide power for the repeater system 10 while the repeater system 10 is configured to provide internet access for the first PGS 20a and the second PGS 20b.

FIG. 8 shows multiple PGS 20a-20b coupled to a repeater system 10 with an intra-and inter-remote management module pair. One repeater system 10 is capable of providing internet access to multiple PGS 20a-20b units through the intra-RMM 18. The coupled path within the intra-remote management module can be established as a wired connection and/or a wireless connection.

FIG. 9 is an illustration of an example of one repeater system 10 providing internet access to multiple PGS units 20a-20c. The overall setup consists of multiple PGS units 20a-20c and various electrical power loads, including the repeater system 10, a lighting system 40, and an HVAC system 45. Additional electrical power loads 27 can be integrated into the setup by pairing them with corresponding PGS units 20.

The system 200 further comprises of an artificial intelligence engine 50 at a remote server configured to prioritize power distribution for all loads to maximize overall system uptime. FIG. 10 is an illustration of a cloud AI engine 50 introduced to manage the multiple PGS 20a-b. The cloud AI engine 50 dynamically and efficiently manages the power supply for the entire system 200. By training on historical data from each load and the cloud, the AI can predict the power generation and electrical power load consumption. Using these inputs, the well-trained AI model optimizes power distribution to maximize system uptime.

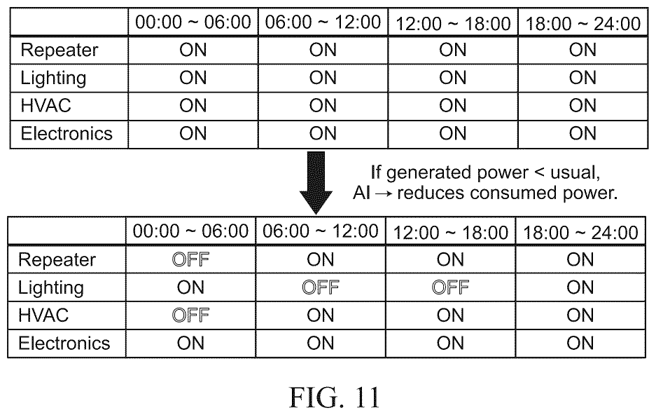

FIG. 11 illustrates an example of AI-driven power optimization for the overall system. If generated power is less than usual, then AI kicks in to reduce consumed power. When the AI predicts that power will be insufficient to fully support the repeater system, it schedules a shutdown from 00:00 to 06:00 for the repeater. This decision is based on the observation that cellular usage is not needed during this time period. During daytime (06:00 to 18:00), the lighting system is not needed. To conserve power for nighttime consumption, the AI engine 50 will turn off the lighting system during this period. Similarly, for the HVAC system, if the AI engine 50 predicts that the available power cannot sustain operation for the entire day, it will turn off the HVAC during the least critical time periods to optimize power usage.

One example of a repeater utilized with the system of the present invention is the LIGHTHOUSE 5G TDD Smart Network Controlled Repeater from Airgain, Inc. The LIGHTHOUSE™ repeater is a next-generation, high-power (>27 dBm OP, >40 dBm EIRP) 5G Smart Network Controlled Repeater (NCR). Designed to extend cellular coverage while enhancing uplink/downlink signal power, the LIGHTHOUSE repeater provides carrier-grade performance with unprecedented deployment simplicity. With the ability to deploy outdoor-to-outdoor solution, the LIGHTHOUSE repeater extends 5G connectivity where it is needed the most. The LIGHTHOUSE™ repeater currently supports 5G NR n78 and other communication bands can be supported including LTE. The LIGHTHOUSE™ repeater features an optional smart integrated donor antenna with beam-steering capabilities, simplifying installation and optimizing signal acquisition, or an external DU antenna. Advanced channelization (10-200 MHz compliant to 3GPP TS 38.106) allows operators to selectively amplify desired signals while mitigating interference. Automated functionalities, including Time Division Duplex (TDD) detection, Automatic Gain Control (AGC), and echo cancellation ensure stable, high-quality signal amplification. The LIGHTHOUSE repeater supports up to 200 MHz instantaneous bandwidth (with 10 MHz steps), 2-carrier aggregation (2CA), and 2×2 Multiple-Input Multiple-Output (MIMO) across its operational bandwidth (3300-4000 MHz). It has a maximum gain of 40-85 dB. The power consumption is less than 110 Watts, with an AC power of 114-126V, 60 Hz, 207-253V, 50 Hz, 114-126V, 60 Hz and 207-253V, 50 Hz. It has. Local control of Wi-Fi 802.11 b/g/n and a remote control unit with a cellular IoT modem, 802.11 b/g/n, and Gigabit Ethernet.

The LIGHTHOUSE repeater can be utilized as part of the system disclosed above. Those skilled in the art will recognize that other repeater sub-systems can be utilized without departing from the scope and spirit of the present invention.

He, U.S. Pat. No. 9,362,621 for a Multi-Band LTE Antenna is hereby incorporated by reference in its entirety.

Abramov et al., U.S. Pat. No. 7,215,296 for a Switch Multi-Beam Antenna Serial is hereby incorporated by reference in its entirety.

Salo et al., U.S. Pat. No. 7,907,971 for an Optimized Directional Antenna System is hereby incorporated by reference in its entirety.

Abramov et al., U.S. Pat. No. 7,570,215 for an Antenna device with a controlled directional pattern and a planar directional antenna is hereby incorporated by reference in its entirety.

Abramov et al., U.S. Pat. No. 7,570,215 for an Antenna device with a controlled directional pattern and a planar directional antenna is hereby incorporated by reference in its entirety.

Abramov et al., U.S. Pat. No. 8,423,084 for a Method for radio communication in a wireless local area network and transceiving device is hereby incorporated by reference in its entirety.

Khitrik et al., U.S. Pat. No. 7,336,959 for an Information transmission method for a wireless local network is hereby incorporated by reference in its entirety.

Khitrik et al., U.S. Pat. No. 7,043,252 for an Information transmission method for a wireless local network is hereby incorporated by reference in its entirety.

Abramov et al., U.S. Pat. No. 8,184,601 for a METHOD FOR RADIO COMMUNICATION IN A WIRELESS LOCAL AREA NETWORK WIRELESS LOCAL AREA NETWORK AND TRANSCEIVING DEVICE is hereby incorporated by reference in its entirety.

Abramov et al., U.S. Pat. No. 7,627,300 for a Dynamically optimized smart antenna system is hereby incorporated by reference in its entirety.

Abramov et al., U.S. Pat. No. 6,486,832 for a Direction-agile antenna system for wireless communications is hereby incorporated by reference in its entirety.

Yang, U.S. Pat. No. 8,081,123 for a COMPACT MULTI-LEVEL ANTENNA WITH PHASE SHIFT is hereby incorporated by reference in its entirety.

Nagaev et al., U.S. Pat. No. 7,292,201 for a Directional antenna system with multi-use elements is hereby incorporated by reference in its entirety.

Abramov et al., U.S. Pat. No. 7,696,948 for a Configurable directional antenna is hereby incorporated by reference in its entirety.

Abramov et al., U.S. Pat. No. 7,965,242 for a Dual-band antenna is hereby incorporated by reference in its entirety.

Abramov et al., U.S. Pat. No. 7,729,662 for a Radio communication method in a wireless local network is hereby incorporated by reference in its entirety.

Abramov et al., U.S. Pat. No. 8,248,970 for an OPTIMIZED DIRECTIONAL MIMO ANTENNA SYSTEM is hereby incorporated by reference in its entirety.

Visuri et al., U.S. Pat. No. 8,175,036 for a MULTIMEDIA WIRELESS DISTRIBUTION SYSTEMS AND METHODS is hereby incorporated by reference in its entirety.

Yang, U.S. Patent Publication Number 20110235755 for an MIMO Radio System With Antenna Signal Combiner is hereby incorporated by reference in its entirety.

Yang et al., U.S. Pat. No. 9,013,355 for an L SHAPED FEED AS PART OF A MATCHING NETWORK FOR A MICROSTRIP ANTENNA is hereby incorporated by reference in its entirety.

Thill, U.S. Pat. No. 10,109,918 for a Multi-Element Antenna For Multiple bands Of Operation And Method Therefor, which is hereby incorporated by reference in its entirety.

Iellici, U.S. Pat. No. 10,305,182 for a Balanced Antenna is hereby incorporated by reference in its entirety.

He et al., U.S. Pat. No. 10,164,324 for Antenna Placement Topologies For Wireless Network System Throughputs Improvement is hereby incorporated by reference in its entirety.

Yang, U.S. Pat. No. 9,912,043 for an Antenna System For A Large Appliance is hereby incorporated by reference in its entirety.

Thill et al., U.S. Pat. No. 8,669,903 for a Dual Frequency Band Communication Antenna Assembly Having AN Inverted F Radiating Element is hereby incorporated by reference in its entirety.

Thill et al., U.S. Pat. No. 6,850,191 for a Dual Frequency Band Communication Antenna is hereby incorporated by reference in its entirety.

Thill et al., U.S. Pat. No. 6,087,990 for a Dual Function Communication Antenna is hereby incorporated by reference in its entirety.

Thill, U.S. Pat. No. 10,511,086 for an Antenna Assembly For A Vehicle is hereby incorporated by reference in its entirety.

He et al., U.S. Pat. No. 10,868,354, for a 5G Broadband Antenna is hereby incorporated by reference in its entirety.

He et al., U.S. Pat. No. 11,296,412, for a 5G Broadband Antenna is hereby incorporated by reference in its entirety.

Stoytchev, U.S. Pat. No. 11,239,564, for an Co-Located Dipoles With Mutually-Orthogonal Polarization, is hereby incorporated by reference in its entirety. Montgomery, U.S. Pat. No. 11,133,589, for an Antenna, is hereby incorporated by reference in its entirety. Wang, U.S. Pat. No. 11,652,279 for a 5G Ultra-Wideband Monopole Antenna, is hereby incorporated by reference in its entirety. Wang et al., U.S. Pat. No. 11,757,186 for a 5G Ultra-Wideband Dipole Antenna, is hereby incorporated by reference in its entirety.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

We claim as our invention the following:

1. A system comprising:
a power generating sub-system (PGS) comprising at least one power generating unit, a charge controller, a battery unit, and a PGS remote management module comprising a remote management (RM) antenna;
a repeater sub-system comprising a service unit (SU) antenna, a SU transceiver, a SU remote management module, a digital processing unit, a donor unit (DU) antenna, and a DU transceiver;
wherein the PGS is configured to provide power for the repeater system while the repeater system is configured to provide internet access for the PGS.

2. The system according to claim 1 wherein the PGS further comprises an inverter.

3. The system according to claim 1 further comprising a HVAC unit.

4. The system according to claim 1 further comprising a lighting sub-system.

5. The system according to claim 1 further comprising an artificial intelligence engine at a remote server configured to prioritize power distribution for all loads to maximize overall system uptime.

6. A system comprising:
a first power generating sub-system (PGS) comprising at least one power generating unit, a charge controller, a battery unit, and a first PGS intra-remote management module comprising a remote management (RM) antenna;
a second PGS comprising at least one power generating unit, a charge controller, a battery unit, and a second PGS intra-remote management module comprising a remote management (RM) antenna
a repeater sub-system comprising a service unit (SU) antenna, a SU transceiver, an intra-remote management module, an inter-remote management module, a digital processing unit, a donor unit (DU) antenna, and a DU transceiver;
wherein the repeater sub system intra-remote management module is connected to the first PGS intra-remote management module PGS and the second PGS intra-remote management module;
wherein the first PGS or the second PGS are configured to provide power for the repeater system while the repeater system is configured to provide internet access for the first PGS and the second PGS.

7. The system according to claim 6 wherein the first PGS further comprises an inverter.

8. The system according to claim 6 further comprising a HVAC unit.

9. The system according to claim 6 further comprising a lighting sub-system.

10. The system according to claim 6 further comprising an artificial intelligence engine at a remote server configured to prioritize power distribution for all loads to maximize overall system uptime.
